(19) United States
(12) Patent Application Publication
(10) Pub. No.: US 2025/0335942 A1
(43) Pub. Date: Oct. 30, 2025

(54) SYSTEMS AND METHODS FOR FORECASTING WEAK DATA SETS

(71) Applicant: NBCUniversal Media, LLC, New York, NY (US)

(72) Inventors: Jay Sherman, Bronx, NY (US); Haree Srinivasan, San Francisco, CA (US); Motoharu Dei, New York, NY (US); Robert Davis, Dingmans Ferry, PA (US)

(21) Appl. No.: 18/649,606

(22) Filed: Apr. 29, 2024

(51) Int. Cl. G06Q 30/0202

(52) U.S. Cl. CPC G06Q 30/0202

(57) ABSTRACT

Systems and methods are provided to accurately forecast weak content units not having sufficient historical viewership data for accurate forecasting. Historical data of a strong Nearest Neighbor unit having a matching video series or site section may be used to supplement the historical data of the weak unit to enable more accurate forecasting of the weak unit.

### BACKGROUND

The present disclosure relates generally to digital content and more specifically to techniques that may be utilized when forecasting weak datasets. More particularly, the forecasting may pertain to future predicted impressions associated with particular content provided via a particular provision platform.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In media and entertainment, content providers and/or content provisioning services may desire forecasts of future content effectiveness to control forecast-dependent activities. For example, content budgeting for future content, content scheduling, and/or content rights retention may be set upon such forecasts, helping to ensure proper monetization of current and/or future content. For example, unique and/or total impressions associated with content variables (herein referred to as “video series”) may be forecasted to identify an effectiveness of the content with respect to members of a content provisioning service that provides the content to the members. Based upon the content's effectiveness, downstream processes and/or systems may be controlled, such as by suggesting and/or limiting content rights retention and/or selling, recommending and/or limiting content scheduling and/or provision timelines, etc. “Unique impressions” refers to the number of users or households that have and/or will be expected to view content. “Total impressions” refers to a number of times the content will been seen. In other words, a single user or household seeing the same content twice is equal to one unique impression and two total impressions.

Unfortunately, current forecasting techniques rely on robust historical data with respect to the content being forecasted. These forecasting techniques are highly ineffective for “weak” datasets having reduced amounts of suitable historical data for forecasting. Thus, traditional forecasting methods are ineffective for new content being offered on a content provisioning service that does not have robust viewership history, re-introduced content that has a robust viewership history that is not recent (e.g., not within the last year), or other content that does not have suitable robust viewership history.

Further, a number of variables other than the content itself may affect the forecasting. For example, viewership may vary drastically between particular platform (herein referred to as “site sections”) and/or platform variables used to access the content, such as the content provisioning services and/or end-user devices used to access the content. Thus, numerous discrete combinations of content and site sections (herein referred to as “units”) may exist, each with their own forecast and need for robust historical data. This robust history is oftentimes lacking, especially as content is released on new platforms, accessed via new end-user device types, etc.

Given the factors discussed above, forecasting using traditional techniques is oftentimes unreliable. Further, given the number of discrete of content and site sections, it is infeasible to rely on human subjectivity for such forecasting at the unit level. Thus, a need exists for more-effective forecasting and control for such “weak” units to perform more accurate and efficient forecasting for downstream control at the unit level.

### BRIEF DESCRIPTION

In one embodiment, a tangible, non-transitory, computer-readable medium, includes computer-readable instructions that, when executed by one or more processors of one or more computers, cause the one or more computers to: identify discrete units from a time series data structure associated with historical data of a plurality of content; identify, from the discrete units, a weak unit not having a threshold amount of historical data for forecasting; determine a nearest neighbor discrete unit having the threshold amount of historical data for forecasting; and cause forecasting of content based on the weak unit and the determined nearest neighbor discrete unit.

In another embodiment, a computer-implemented method, includes: identifying discrete units from data time series data structure associated with historical data of a plurality of content; identifying, from the discrete units, a weak unit not having a threshold amount of historical data for forecasting; determining a nearest neighbor discrete unit having the threshold amount of historical data for forecasting; and causing forecasting of content based on the weak unit and the determined nearest neighbor discrete unit.

In yet another embodiment, a system, includes: a forecasting service, hosted by a first electronic device, configured to: receive historical data associated with a discrete unit of content having one or more particular video series characteristics and one or more particular site section characteristics; and forecast viewership for the content using the historical data associated with the discrete unit. The system also includes a nearest neighbor identification service, hosted by a second electronic device, configured to: identify the discrete unit as a weak unit not having a threshold amount of historical data for forecasting; determine a nearest neighbor discrete unit having the threshold amount of historical data for forecasting; and associate the historical data of the nearest neighbor discrete unit with the discrete unit to cause the forecasting service to forecast the viewership of the content based upon the nearest neighbor discrete unit and the discrete unit.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings. The patent or application file contains at least one drawing executed in color. Copies of this patent or patent application publication with color drawing(s) will be provided by the Office upon request and payment of the necessary fee.

FIG. 1 is a block diagram of a system that forecasts unit viewership, in accordance with one or more embodiments of the present disclosure;

FIG. 2 is a flow diagram of a process for unit viewership forecasting, in accordance with one or more embodiments of the present disclosure;

FIG. 3 is a schematic diagram, illustrating an example time series matrix (TSM) data structure useful for efficient identification of discrete units for forecasting, in accordance with one or more embodiments of the present disclosure; and

FIG. 4 is a schematic diagram, illustrating identification of discrete units in the TSM data structure, in accordance with one or more embodiments of the present disclosure;

FIG. 5 is a flow diagram of a process for identifying “strong” nearest neighbor units for forecasting purposes, in accordance with one or more embodiments of the present disclosure;

FIG. 6 is a schematic diagram, illustrating an example of matching weak units to strong units based upon video series and/or site segments, in accordance with one or more embodiments of the present disclosure;

FIG. 7 is a schematic diagram, illustrating a filtering of matches to prefer site segment matches over video series matches, in accordance with one or more embodiments of the present disclosure;

FIG. 8 is a flow diagram, illustrating a process for identifying “strongest” matches, in accordance with one or more embodiments of the present disclosure;

FIG. 9 is a schematic diagram, illustrating an example aggregation of strong unit historical data with weak unit historical data for forecasting purposes, in accordance with one or more embodiments of the present disclosure; and

FIG. 10 illustrates an example of system control based upon forecasting via aggregated strong unit historical data with weak unit historical data, in accordance with one or more embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

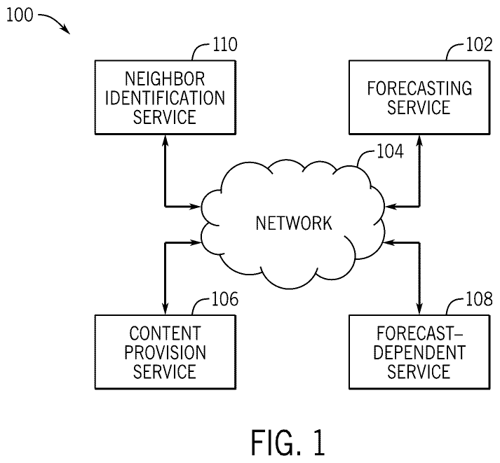

Turning now to the drawings, FIG. 1 is a block diagram of a system 100 that forecasts unit viewership, in accordance with one or more embodiments of the present disclosure. As illustrated, the system 100 includes a forecasting service 102 communicatively coupled to a network 104. As mentioned above, the forecasting service 102 may provide forecasting (e.g., of future viewership) based upon historical data (e.g., historical viewership provided by a content provision service 106, which, in some cases may be an Internet content streaming service). The forecasting may be useful to control downstream forecast-dependent services 108, which may include content scheduling services, content rights management services, future content planning services, etc.

For some content and/or content on particular platforms, there may not be enough recent historical information to generate accurate forecasting via forecasting models of the forecasting service 102. Accordingly, a neighbor identification service 110 may be used to identify a historical dataset that incorporates a history from similar video series and/or site units having robust historical data. For example, when content is newly introduced and/or is re-introduced after a hiatus, there may not be enough recent historical information to forecast future viewership, causing the content and/or content and platform to be a “weak” unit without enough historical data for accurate forecasting. Accordingly, the neighbor identification service 110 may provide historical data from similar video series and/or site sections (e.g., “strong” units) to aggregate with whatever historical data is available for the weak unit. In this manner, the historical data of the weak unit may be supplemented with the neighboring unit's historical data to provide more accurate forecasting.

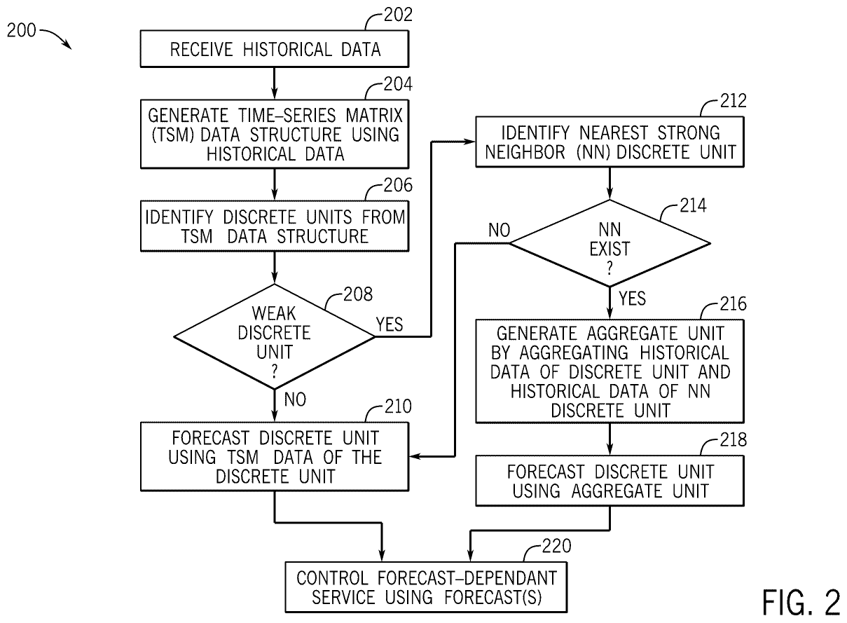

FIG. 2 is a flow diagram of a process 200 for unit viewership forecasting, in accordance with one or more embodiments of the present disclosure. The process 200 begins with receiving historical data regarding one or more content units (block 202). For example, historical viewership data of a content provision system 106 may be obtained from the content provision system 106. The historical data may include log information of past viewership of a variety of content provided by the content provision system 106, particular platforms used for the viewership, particular devices used to view the content, and/or other characteristics associated with the content, access/viewing of the content, and/or the viewer of the content.

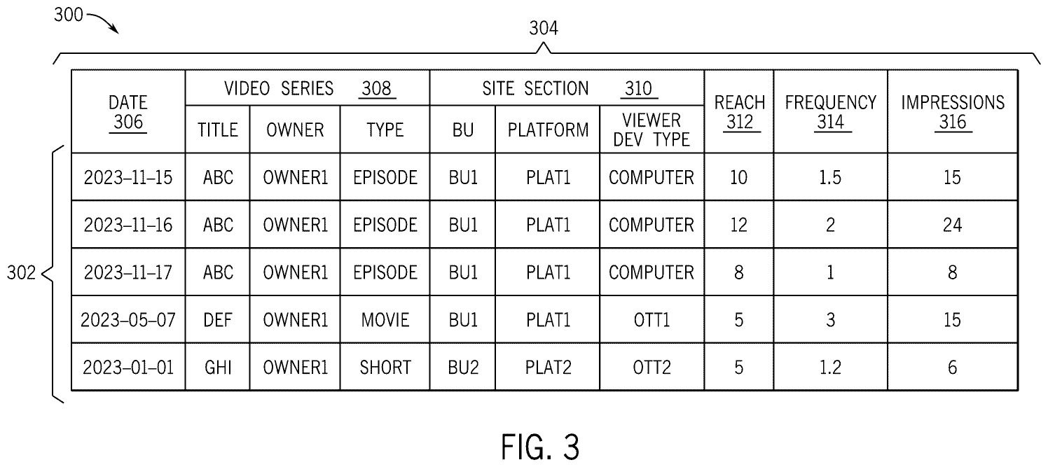

At block 204, a time series data structure (e.g., a time series matrix (TSM) data structure) is generated using the received historical data. For example, FIG. 3 is a schematic diagram, illustrating an example time series matrix (TSM) data structure 300. The TSM data structure 300 may be generated such that it is useful for efficient identification of discrete units for forecasting. For example, in the depicted embodiment, the TSM data structure 300 provides rows 302 of historical viewership data with columns 304 of characteristics of the historical viewership data. For example, in the depicted embodiment, a date 306, content characteristics making up a video series 308, presentation characteristics making up the site section 310, reach 312, frequency 314, and impressions 316 on a particular date 306, for a particular video series 308 and site section 310. As mentioned above, the impressions 316 may be the reach 312 (unique views) multiplied by the frequency 314 of the repeated views.

Returning to FIG. 2, the generated TSM data structure may provide an efficient mechanism with which to identify the discrete units (block 206). For example, the discrete units may be identified by identifying rows having common content characteristics making up a video series 308 and common presentation characteristics making up the site section 310.

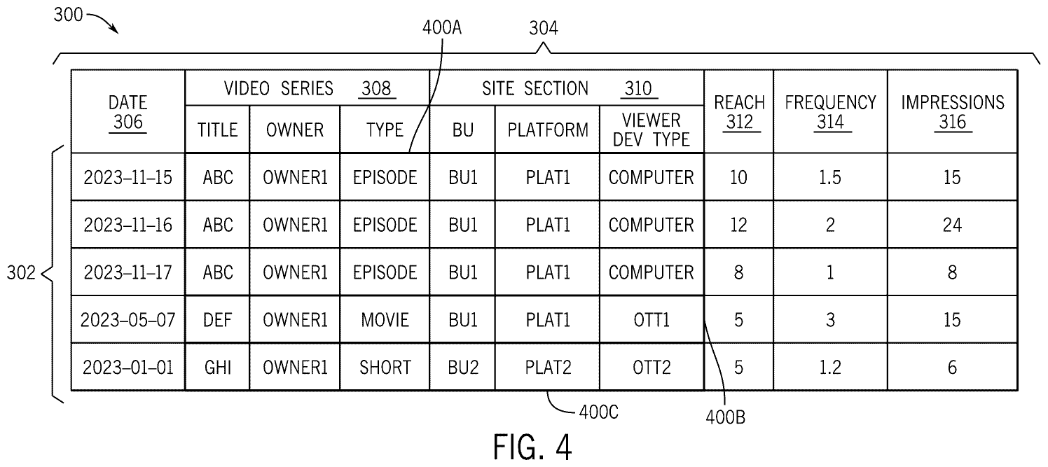

FIG. 4 is a schematic diagram, illustrating an of identification of discrete units 400A, 400B, and 400C (collectively discrete units 400) in the TSM data structure 300. For example, as illustrated, discrete unit 400A includes all rows with the video series 308 combination of Title: ABC, Owner: Owner1, Type: Episode and the site section 310 combination of BU: BU1, Platform: Plat1, Viewer Dev Type: Computer. While discrete units 400B and 400C include some common characteristics, they do not share all of the video series 308 and/or site section 310 characteristics. Accordingly, these are identified as separate discrete units.

For each of the identified discrete units to be forecasted, a determination is made as to whether the units are weak, meaning they do not have sufficient recent historical data for forecasting (decision block 208). In some embodiments, this may be determined by identifying a count of rows for the discrete unit that fall within a recent history date range (e.g., last 60 days) to determine if the historical data meets a threshold (e.g., 30 or 60 days and/or rows of history) of recent history availability and/or it has ales than 10 total days of historical data). In other embodiments, other criteria may be used to identify that a unit does not have sufficient data for forecasting.

If weakness criteria is not met (e.g., there is enough historical data), the discrete unit is deemed non-weak and forecasting is performed using the historical data of the discrete unit (block 210). However, if the discrete unit is weak, the nearest strong neighboring discrete unit (“nearest neighbor”) is identified (block 212). The nearest neighbor may be a discrete unit may be derived from a subset of discrete units with enough recent historical data to supplement the historical data of the weak discrete unit. As will be discussed in more detail below, the nearest neighbor is identified as a most preferred one of the subset of discrete units that shares a common video series and has at least some commonalities in site section characteristics or has a common site section and has at least some commonalities in video series characteristics.

At decision block 214, a determination is made as to whether a nearest neighbor exists for the weak discrete unit. If not, the weak discrete unit may be forecasted using only its historical data (block 210). However, because this forecast may be inaccurate, in some embodiments, an alert may be provided (e.g., via a graphical user interface) indicating that the forecasting may be inaccurate and/or providing an indication that the forecasting will not be completed until sufficient historical data may be obtained (e.g., via subsequent accumulation of historical data for the discrete unit and/or subsequently identifying a nearest neighbor).

When a nearest neighbor does exist at decision block 214, an aggregated unit may be generated by aggregating the historical data of the weak discrete unit with the historical data of the nearest neighbor (block 216). The weak discrete unit may then be forecasted using the aggregated unit (block 218), which will have enough historical data for an accurate forecast by the forecasting models.

The forecast may be used to control forecast-dependent service(s) (block 220). For example, the forecast may be used to provide graphical user interface alerts, affordance controls, and/or electronic recommendations to downstream services based upon the forecast.

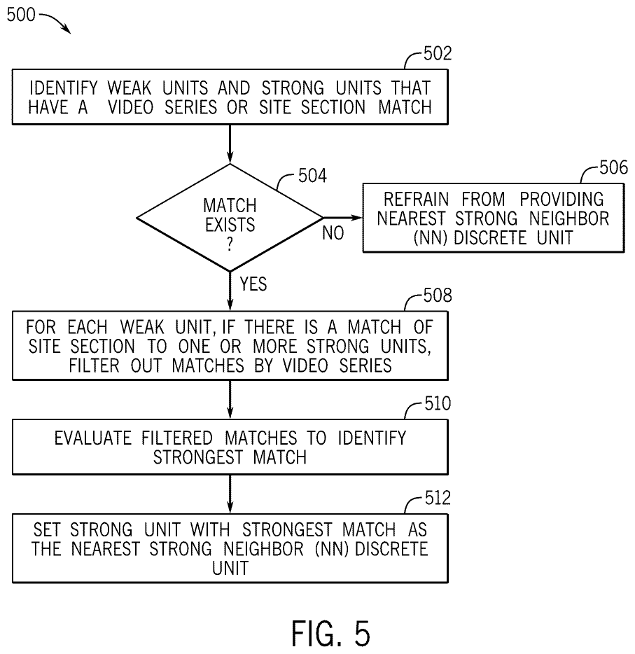

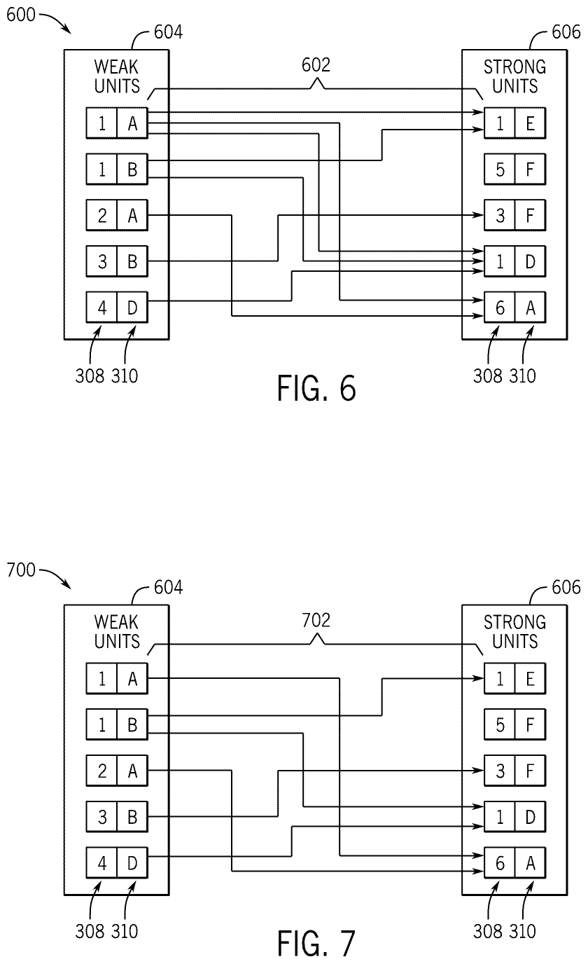

Turning to a more detailed discussion of identifying the nearest neighbor, FIG. 5 is a flow diagram of a process 500 for identifying “strong” nearest neighbor units for forecasting purposes, in accordance with one or more embodiments of the present disclosure. The process 500 begins with identifying weak units and strong units that have a video series or a site section match. FIG. 6 is a schematic diagram, illustrating an example 600 of identifying matches of weak units to strong units based upon video series and/or site segments, in accordance with one or more embodiments of the present disclosure. As illustrated, weak unit 1A matches strong units 1E and 1D, based upon having a common video series 308 of “1” and matches strong unit 6A based upon having a common site section “A”. Matches for the other week units 604 are also identified.

At decision block 504, a determination is made as to whether a match to a strong unit exists for each of the weak units. If no matches exists for a particular weak unit, no nearest neighbor is provided/identified for that particular weak unit (block 506). However, when matches do exist, prioritization of one of the matching strong units is performed to identify the nearest neighbor.

It may be desirable to prioritize certain types of matches. For example, it may be desirable to prioritize site section matches with similar content over video series matches with uncommon (or different) site sections, as varied site sections may be identified with more varied viewership than similar content with the same site section. Accordingly, returning to FIG. 5, at block 508, in some embodiments, for each weak unit that has a site section match to a strong unit, the matches by video series may be discarded/filtered out.

Continuing with the example of FIG. 6, FIG. 7 is a schematic diagram, illustrating an example 700 of filtered matches 702 to prefer site segment matches over video series matches, in accordance with one or more embodiments of the present disclosure. As illustrated, with respect to weak unit 1A, the matches to strong units 1E and 1D are filtered out, as these were matches based upon video series 308 and a site section match to strong unit 6A exists. This results in only the matches to site sections being retained when such matches exist and otherwise retaining the video series matches. For example, weak unit 1B does not have any site section matches and, thus, the matches to strong units 1E and 1D are retained in the filtered matches 702.

At block 510, the filtered matches are evaluated to identify the strongest match. The strongest match is set as the nearest neighbor and is used for forecasting of the corresponding weak unit (block 512).

In some embodiments, suitable matches may only be found when the match includes a complete match with respect to one of the video series or the site section and a partial match of characteristics of the other of the video series or the site section. The partial match may require particular common characteristics between the weak unit and the strong unit to be a suitable match for forecasting purposes. Further, to identify the strongest suitable match, the partially matching characteristics may be weighted to identify the most suitable or “strongest” match.

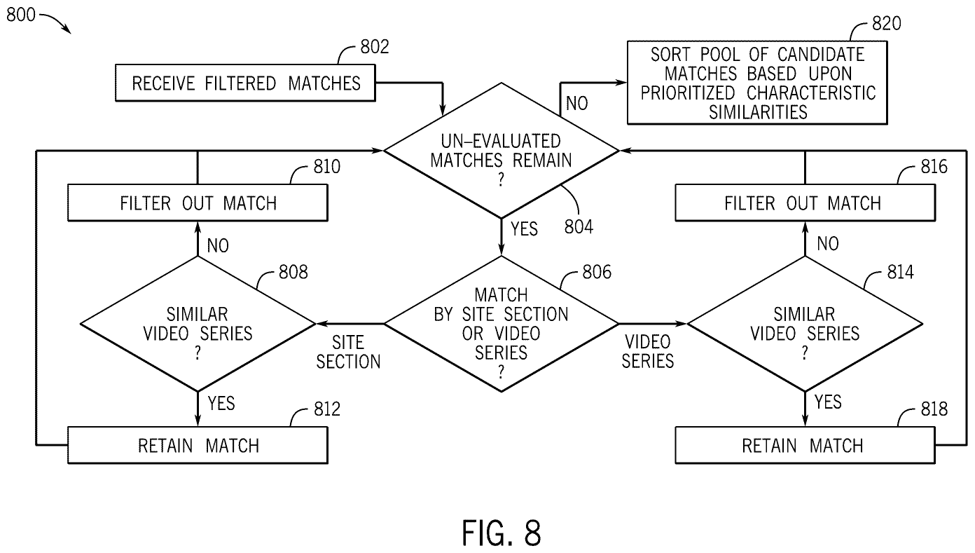

FIG. 8 is a flow diagram, illustrating a process 800 for identifying “strongest” matches, in accordance with one or more embodiments of the present disclosure. The process 800 begins with receiving the filtered matches (e.g., as discussed with respect to block 508 of FIG. 5) (block 802).

At decision block 804, a determination is made as to whether any of the received filtered matches have been un-evaluated for suitability and/or strength with respect to the other matches. At initial receipt, each of the filtered matches is un-evaluated.

When un-evaluated matches exist, for each of the matches, a determination is made as to whether the match is a site section match or a video series match (decision block 806). When the match is a site section match, a determination is made as to whether the video series characteristics meet threshold similarity requirements for suitability of use of the strong unit for forecasting of the weak unit (decision block 808). For example, in one embodiment, with site section matches, the threshold similarity requirements for the video series characteristics may include: a requirement that the content owner of the content matches, that a type of the content matches, and/or that the content names have a threshold level of similarity, which may be determined using a word similarity method, such as a bag-of-words function (e.g., BM25) that identifies word similarities.

When the video series characteristics of the match do not meet the threshold similarity requirements, the match is filtered out (block 810). In other words, the match is removed from a pool of matches that may identify candidate nearest neighbors to supplement viewership history for the weak unit.

However, when the video series characteristics of the match do meet the threshold similarity requirements, the match is retained in the pool of matches that may identify candidate nearest neighbors (block 812).

Returning to decision block 806, when the match is a video series match, a determination is made as to whether the site section characteristics meet threshold similarity requirements for suitability of use of the strong unit for forecasting of the weak unit (decision block 814). For example, in one embodiment, with video series matches, the threshold similarity requirements for the site section characteristics may include a requirement that the business unit (e.g., a business and/or portion of a business associated with the content, such as content creator and/or owner, such as NBC Universal Media, LLC, a local broadcasting affiliate, the News Group of an business, etc.) of the site section matches between the weak unit and the strong unit, that a platform (e.g., linear vs. digital streaming provider of playback, and/or a specific provision service, such as NBC, Peacock, Vudu, etc.) that the content is delivered to matches between the weak unit and the strong unit, etc.

When the site section characteristics of the match do not meet the threshold similarity requirements, the match is filtered from the pool of matches that may identify candidate nearest neighbors (block 816). However, when the site section characteristics of the match do meet the threshold similarity requirements, the match is retained in the pool of matches that may identify candidate nearest neighbors (block 818).

This process continues until no further un-evaluated matches remain at decision block 804. When no un-evaluated matches remain, the pool of candidate matches are sorted based upon the prioritized characteristic similarities (block 820). For example, in one embodiment, for site section matches, the matches may be sorted based upon a magnitude of similarities in the content names of the weak unit and the strong unit. If there is tie between magnitudes of similarities in the content names, a unit of the tied strong units having a median value of the historical data (e.g., reach) may be determined and used in the aggregated unit.

For video series matches, the matches may be sorted based on prioritized commonalities of site section data. For example, commonalities of a type of user accessing the content (e.g., Free, Premium, Premium+, Teen, Kids) may be prioritized over commonality of an account type used to access the content (e.g., Free, Premium, Premium+). The matching account type may be prioritized over a matching device type used to access the content. The matching device type may be prioritized over a matching device operating system used to access the content, etc. In some embodiments, the number of matching characteristics may play a factor in the prioritization. For example, a match of device type and operating system may, in some embodiments, be prioritized as a stronger match than one that matches on fewer characteristics, even when the fewer characteristics have a higher priority individually than the device type or operating system.

If there is tie between magnitudes of similarities in the content names, and thus tied strong units, a unit from the tied strong units having a median value of the historical data s may be determined an used in the aggregated unit.

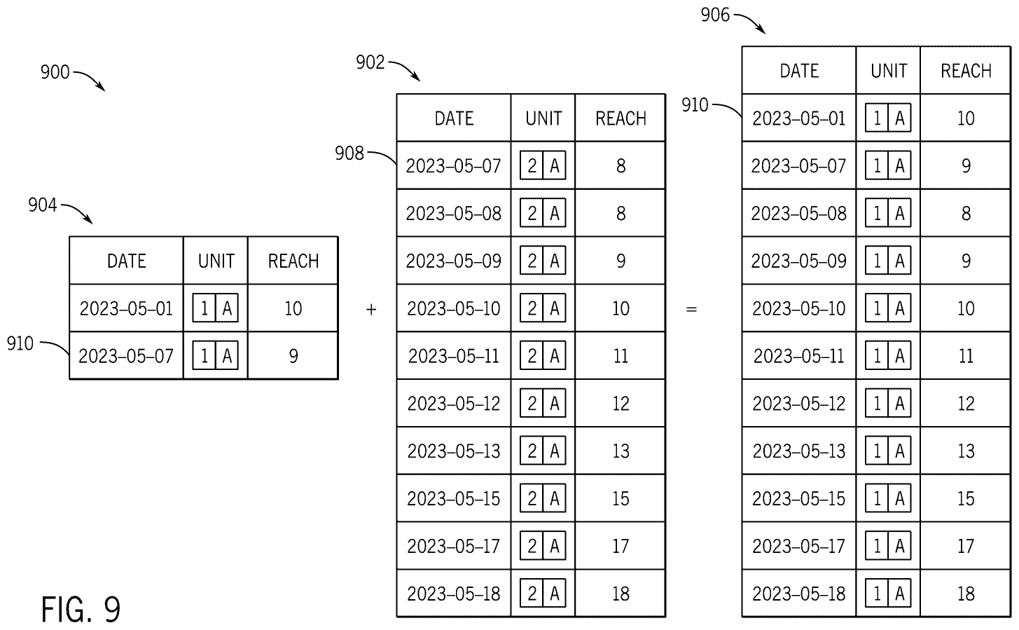

From the sorted list of candidate matches, the strong units associated with the strongest matches for each weak unit may be selected as the nearest neighbor for the corresponding weak link. As mentioned above, the historical data of the nearest neighbor may be aggregated with the historical data of the weak unit, enabling more accurate forecasting of the weak unit. FIG. 9 is a schematic diagram, illustrating an example aggregation 900 of strong unit historical data 902 with weak unit historical data 904 to generate an aggregated unit 906 for forecasting purposes, in accordance with one or more embodiments of the present disclosure.

As illustrated, in the current embodiment, the aggregation includes appending historical data of the strong historical data that does not overlap the weak unit historical data 904 to the weak unit historical data 904. For example, entry 908 of the strong unit historical data 902 has a date of May 7, 2023. Entry 910 of the weak unit historical data 904 has the same date. Accordingly, these entries overlap one another and, thus, the aggregated unit 906 includes entry 910 of the weak unit historical data 904 but not entry 908 of the strong unit historical data 902. In this manner, the forecasting may be made based upon as much suitable historical data of the weak unit as possible, while being supplemented with a similar strong unit's historical data. In another aspect, entry 908 of the strong unit historical data 902 may replace entry 910 of the weak unit historical data 904.

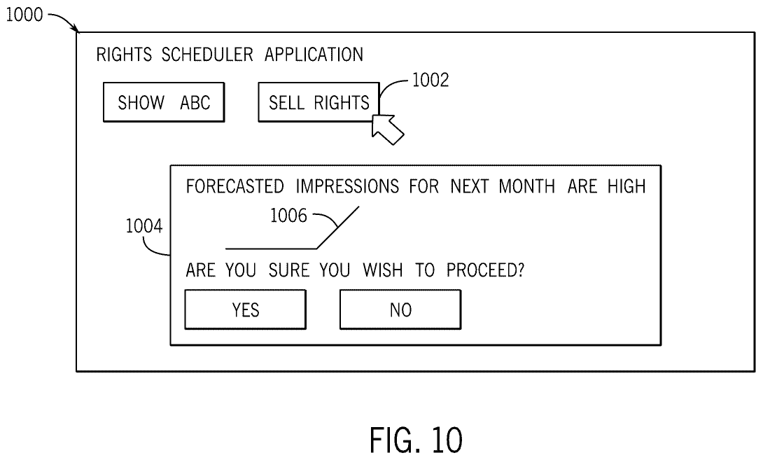

FIG. 10 illustrates an example of system control based upon forecasting via aggregated strong unit historical data with weak unit historical data, in accordance with one or more embodiments of the present disclosure. Specifically, FIG. 10 illustrates a forecast-controlled graphical user interface 1000 where graphical controls and/or elements are controlled based upon forecasting data (e.g., provided by the forecasting service 102). Any number of GUI elements may be controlled based upon the forecasting data. For example, in the GUI 1000, for show ABC, forecasting of the show ABC may indicate that forecasted impressions for next month exceed a threshold, indicating that the forecasted impressions will be relatively high. Upon selection of an affordance 1002 requesting to sell rights to show ABC, a graphical alert 1004 may be provided, requesting confirmation of the request in view of the next month's forecasted impressions being high. In some embodiments, a forecasting trend diagram 1006 may be provided to further emphasize and/or provide details regarding the forecast.

In some embodiments, GUI 1000 controls may be altered based upon the forecast. For example, in lieu of providing the graphical alert 1004 upon selection of affordance 1002, the affordance 1002 may be disabled based upon the forecast exceeding a particular threshold. In this manner, a request to sell rights may not be made when a future impression forecast exceeds the particular threshold, ensuring that the rights are not sold before the impressions are realized.

The example of FIG. 10 provides one example of forecast-control of systems. However, many other forecast controlled systems are envisioned. For example, forecasting of supplemental content (e.g., advertisement) capacity for particular units, may be used to control supplemental content ordering systems to encourage ordering within forecasted capacities. By utilizing the techniques described herein, accurate forecasting for discrete units with weak estimations of the availability of supplemental content may be achieved in a relatively fast manner (e.g., one hour or two hours compared to days or weeks).

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A tangible, non-transitory, computer-readable medium, comprising computer-readable instructions that, when executed by one or more processors of one or more computers, cause the one or more computers to:
identify discrete units from a data structure associated with historical data of a plurality of content;
identify, from the discrete units, a weak unit not having a threshold amount of historical data for forecasting;
determine a nearest neighbor discrete unit having the threshold amount of historical data for forecasting; and
cause forecasting of content based on the weak unit and the determined nearest neighbor discrete unit.

2. The tangible, non-transitory, computer-readable medium of claim 1, wherein the data structure comprises a time-series matrix (TSM) data structure and the tangible, non-transitory, computer-readable medium comprises computer-readable instructions that, when executed by the one or more processors of the one or more computers, cause the one or more computers to:
identify the discrete units as rows of the TSM data structure having a common video series characteristic and a common site section characteristic.

3. The tangible, non-transitory, computer-readable medium of claim 2, wherein:
the common video series characteristic comprises: a content name, an owner of the content, or a type of the content, or any combination thereof; and
the common site section characteristic comprises: a business unit associated with a playback of content, a platform corresponding to the playback, or a device type of a playback device used for the playback, or any combination thereof.

4. The tangible, non-transitory, computer-readable medium of claim 2, comprising computer-readable instructions that, when executed by the one or more processors of the one or more computers, cause the one or more computers to identify the nearest neighbor discrete unit for the weak unit, by:
identifying strong discrete units from the identified discrete units having the threshold amount of historical data for forecasting;
identifying from the strong discrete units, a subset of matching strong discrete units that match either one or more video series characteristics or one or more site section characteristics of the weak unit;
determining a preferred match from the subset of matching strong discrete units; and
selecting the preferred match as the nearest neighbor discrete unit for the weak unit.

5. The tangible, non-transitory, computer-readable medium of claim 4, comprising computer-readable instructions that, when executed by the one or more processors of the one or more computers, cause the one or more computers to identify the subset of matching strong discrete units, by:
for a match with matching site section characteristics:
determine if video series similarity criteria between the video series characteristics of the weak unit and a unit corresponding to the match with matching site section characteristics are met; and
identify the match with matching site section characteristics as a matching strong discrete unit when the video series similarity criteria are met; and
for a match with matching video series characteristics:
determine if site section similarity criteria between the site section characteristics of the weak unit and a unit corresponding to the match with matching video series characteristics are met; and
identify the match with matching video series characteristics as a matching strong discrete unit when the site section similarity criteria are met.

6. The tangible, non-transitory, computer-readable medium of claim 5, wherein the video series similarity criteria comprises: a requirement that a content owner match, a requirement that a type of the content match, a requirement that content names have a threshold level of similarity, or any combination thereof.

7. The tangible, non-transitory, computer-readable medium of claim 6, wherein the site section similarity criteria comprises: a requirement that a business unit match, a requirement that a platform that the content is delivered to matches, or both.

8. The tangible, non-transitory, computer-readable medium of claim 4, comprising computer-readable instructions that, when executed by the one or more processors of the one or more computers, cause the one or more computers to determine the preferred match, by:
prioritizing matches by site section over matches by video series.

9. The tangible, non-transitory, computer-readable medium of claim 4, comprising computer-readable instructions that, when executed by the one or more processors of the one or more computers, cause the one or more computers to determine the preferred match, by:
for a match with matching site section characteristics: prioritize similarities of a particular subset of the video series characteristics to determine the preferred match; and
for a match with matching video series characteristics: prioritize similarities of a particular subset of the site section characteristics to determine the preferred match.

10. The tangible, non-transitory, computer-readable medium of claim 9, wherein:
the prioritized similarities of the particular subset of the video series characteristics comprise: prioritizing a magnitude of similarities of content names; and
the prioritized similarities of the particular subset of the site section characteristics comprise: prioritizing a type of user accessing the content over a commonality of an account type used to access the content over a matching device type used to access the content over a matching operating system used to access the content.

11. A computer-implemented method, comprising:
identifying discrete units from a data structure associated with historical data of a plurality of content;
identifying, from the discrete units, a weak unit not having a threshold amount of historical data for forecasting;
determining a nearest neighbor discrete unit having the threshold amount of historical data for forecasting; and
causing forecasting of content based on the weak unit and the determined nearest neighbor discrete unit.

12. The computer-implemented method of claim 11, comprising:
identifying the discrete units as rows of the data structure having a common video series characteristic of a content and a common site section characteristic of playback of the content;
wherein:
the common video series characteristic comprises: a content name, an owner of the content, or a type of the content, or any combination thereof; and
the common site section characteristic comprises: a business unit associated with the playback, a platform corresponding to the playback, or a device type of a playback device used for playback of the content, or any combination thereof.

13. The computer-implemented method of claim 12, comprising identifying the nearest neighbor discrete unit for the weak unit, by:
identifying strong discrete units from the identified discrete units having the threshold amount of historical data for forecasting;
identifying from the strong discrete units, a subset of matching strong discrete units that match either a video series characteristic or a site section characteristic of the weak unit;
determining a preferred match from the subset of matching strong discrete units; and
selecting the preferred match as the nearest neighbor discrete unit for the weak unit.

14. The computer-implemented method of claim 13, comprising identifying the subset of matching strong discrete units, by:
for a match with matching site section characteristics:
determine if video series similarity criteria between the video series characteristics of the weak unit and a unit corresponding to the match with matching site section characteristics are met; and
identify the match with matching site section characteristics as a matching strong discrete unit when the video series similarity criteria are met; and
for a match with matching video series characteristics:
determine if site section similarity criteria between the site section characteristics of the weak unit and a unit corresponding to the match with matching video series characteristics are met; and
identify the match with matching video series characteristics as a matching strong discrete unit when the site section similarity criteria are met.

15. The computer-implemented method of claim 14, wherein the video series similarity criteria comprises: a requirement that a content owner of the content described in the video series characteristics match, a requirement that a type of the content described in the video series characteristics match, a requirement that content names described in the video series characteristics have a threshold level of similarity, or any combination thereof.

16. The computer-implemented method of claim 15, wherein the site section similarity criteria comprises: a requirement that a business unit of the site section characteristics match, a requirement that a platform that the content is delivered to matches, or both.

17. The computer-implemented method of claim 14, comprising determining the preferred match, by:
prioritizing matches by site section over matches by video series; and
for a match with matching site section characteristics: prioritize similarities of a particular subset of the video series characteristics to determine the preferred match; and
for a match with matching video series characteristics: prioritize similarities of a particular subset of the site section characteristics to determine the preferred match.

18. The computer-implemented method of claim 17, wherein:
the prioritized similarities of the particular subset of the video series characteristics comprise: prioritizing a magnitude of similarities of content names; and
the prioritized similarities of the particular subset of the site section characteristics comprise: prioritizing a type of user accessing the content over a commonality of an account type used to access the content over a matching device type used to access the content over a matching operating system used to access the content.

19. A system, comprising:
a forecasting service, hosted by a first electronic device, configured to:
receive historical data associated with a discrete unit of content having one or more particular video series characteristics and one or more particular site section characteristics; and
forecast viewership for the content using the historical data associated with the discrete unit;
a nearest neighbor identification service, hosted by a second electronic device, configured to:
identify the discrete unit as a weak unit not having a threshold amount of historical data for forecasting;
determine a nearest neighbor discrete unit having the threshold amount of historical data for forecasting; and
associate the historical data of the nearest neighbor discrete unit with the discrete unit to cause the forecasting service to forecast the viewership of the content based upon the nearest neighbor discrete unit and the discrete unit.

20. The system of claim 19, comprising:
a forecast-dependent service configured to receive the forecasting and modify operation based upon the forecasting;
wherein the nearest neighbor identification service is configured to:
identify the nearest neighbor discrete unit, by:
identifying a set of strong discrete units having the threshold amount of historical data for forecasting that matches the one or more particular video series characteristics or the one or more particular site section characteristics;
when at least one of the set of strong discrete units matches the one or more particular site section characteristics, retain the strong discrete units matching the one or more particular site section characteristics and filter out all of the strong discrete units that match the one or more particular video series characteristics;
identify from remaining strong discrete units of the set of strong discrete units, suitable strong discrete units for the nearest neighbor discrete unit, by:
for a strong discrete unit matching the one or more particular site section characteristics:
determine if video series similarity criteria between the one or more particular video series characteristics of the weak unit and the strong discrete unit are met; and
identify the strong discrete unit matching the one or more particular site section characteristics as suitable when the video series similarity criteria are met; and
for a strong discrete unit matching the one or more particular video series characteristics:
determine if site section similarity criteria between the one or more particular site section characteristics of the weak unit and the strong discrete unit are met; and
identify the strong discrete unit matching the particular video series characteristics as suitable when the site section similarity criteria are met; and
from the suitable strong discrete units, identify a preferred suitable strong discrete unit as the nearest neighbor discrete unit.
